(19) United States
(12) Patent Application Publication
(10) Pub. No.: US 2026/0276492 A1
(43) Pub. Date: Sep. 17, 2026

(54) FULL-AUTOMATIC HUMAN PRIMARY CHONDROCYTE EXTRACTION DEVICE

(71) Applicant: The Second Affiliated Hospital of WMU, Wenzhou City (CN)

(72) Inventors: Yimin WENG, Wenzhou City (CN); Xiaojin WU, Wenzhou City (CN); Jiale ZHOU, Wenzhou City (CN); Dingsheng LIN, Wenzhou City (CN); Leyi CAI, Wenzhou City (CN); Liang CHEN, Wenzhou City (CN); Pei FAN, Wenzhou City (CN)

(21) Appl. No.: 19/078,551

(22) Filed: Mar. 13, 2025

(51) Int. Cl. G01N 1/31; G01N 1/28

(52) U.S. Cl. CPC G01N 1/31; G01N 1/286; G01N 2001/2873

(57) ABSTRACT

Provided is a full-automatic human primary chondrocyte extraction device including a chondrocyte extraction table, an operating table board fixedly connected to the chondrocyte extraction table, a detachable operating table arranged in the middle of the operating table board, a support plate fixedly connected to an upper portion of the chondrocyte extraction table, and a parallel guide frame installed on a front end of the support plate. The parallel guide frame is composed of two semicircular frames spliced together, a parallel guide plate is movably connected into the parallel guide frame, a tubular cutter is arranged under the parallel guide plate, three cartilage positioning thrust cylinders are installed on a lower surface of the operating table board, three cartilage pressing plates are movably connected to the operating table board, and two rinsing solution sprayers are installed above the chondrocyte extraction table and connected to a rinsing solution reservoir.

### TECHNICAL FIELD

The present disclosure relates to the technical field of medical experimental devices, and in particular to a full-automatic human primary chondrocyte extraction device.

### BACKGROUND

Human primary chondrocytes are chondrocytes directly extracted from human body without passage. The research on chondrocytes is crucial for the treatment of osteoarthritis. During extracting the human primary chondrocytes, medical devices is required to obtain cartilage samples from the human body and then the cartilage tissue is washed to remove blood and other impurities on the surface of the cartilage tissue. The washed cartilage tissue is cut into small pieces and transferred into culture flasks, and then collagenase-containing culture solution are added to digest the cartilage tissue. When cutting the cartilage tissue, the cartilage tissue is required to be placed into a culture container and fixed by tools such as tweezers, and then the cartilage tissue is cut into tissue blocks with the size of 1 cubic millimeter by means of high-precision medical scissors.

In the existing cutting process of cartilage tissue, due to the high-precision cutting requirements and the extremely small volume of the required tissue blocks, the cutting operation is difficult. Moreover, the traditional cutting workbench lacks a fixing structure for the cartilage tissue, making it impossible to stably position the cartilage tissue. As a result, the cartilage tissue slides during the cutting process, affecting the cutting efficiency of the cartilage tissue. After cutting, it is inconvenient to collect the cartilage tissue, and disassemble and clean the workbench.

### SUMMARY

The embodiment of the disclosure relates to a full-automatic human primary chondrocyte extraction device to solve the problems that in the existing cutting process of cartilage tissue, due to the high-precision cutting requirements and the extremely small volume of the required tissue blocks, the cutting operation is difficult; the traditional cutting workbench lacks a fixing structure for the cartilage tissue, making it impossible to stably position the cartilage tissue, as a result, the cartilage tissue slides during the cutting process, affecting the cutting efficiency of the cartilage tissue; and after cutting, it is inconvenient to collect the cartilage tissue, and disassemble and clean the workbench.

In a first aspect of the present disclosure, a full-automatic human primary chondrocyte extraction device includes a chondrocyte extraction table; an operating table board fixedly connected to the chondrocyte extraction table; a detachable operating table arranged in a middle of the operating table board; a support plate fixedly connected to an inner upper portion of the chondrocyte extraction table; and a parallel guide frame installed on a front end of the support plate. The parallel guide frame is composed of two semicircular frames spliced together via bolts, a parallel guide plate is movably connected into the parallel guide frame, a tubular cutter is arranged under the parallel guide plate, three cartilage positioning thrust cylinders are installed on a lower surface of the operating table board via screws, three cartilage pressing plates are movably connected to the operating table board, and two rinsing solution sprayers are installed above the chondrocyte extraction table and connected to a rinsing solution reservoir.

In at least some embodiments, the full-automatic human primary chondrocyte extraction device further includes two auxiliary lighting components installed on an inner wall of the chondrocyte extraction table via screws, a lighting control switch fixedly connected to a left surface of the chondrocyte extraction table and connected to the two auxiliary lighting components via electrical wires.

In at least some embodiments, the operating table board includes a front edge that is bent upwards; a circular middle opening is provided at a middle of the operating table board, an edge of the middle opening is inclined; three inclined gaskets are fixedly connected to the lower surface of the operating table board and uniformly distributed in a radial pattern around an axis of the middle opening, an inclined surface of each of the three inclined gaskets faces inwards and downwards, and an outer edge of the middle opening is provided with a positioning pad of a convex ring structure.

In at least some embodiments, the full-automatic human primary chondrocyte extraction device further includes three inclined guide openings formed in the operating table board in a penetrating manner and uniformly distributed in a radial pattern around the axis of the middle opening; a centralized conveying hopper fixedly connected to the lower surface of the operating table board and including an upper edge surrounding a lower opening of the middle opening; and a conveying pipe installed on a lower outlet of the centralized conveying hopper.

In at least some embodiments, the detachable operating table is of a truncated cone structure, an outer edge of the detachable operating table is fixedly connected with three support legs, the detachable operating table is installed inside the middle opening, and outer ends of the three support legs are fitted to an inner edge of the middle opening.

In at least some embodiments, the parallel guide frame is internally provided with a circular cavity, a middle of an upper portion of the parallel guide frame is provided with a dismounting opening, an inner diameter of the dismounting opening is equal to a diameter of the parallel guide plate, and a middle of a lower portion of the parallel guide frame is provided with a limit sliding opening.

In at least some embodiments, the full-automatic human primary chondrocyte extraction device further includes a vertical push rod vertically arranged on a middle of a lower surface of the parallel guide plate, a cross section of the vertical push rod being square, and a handle fixedly connected to an upper surface of the parallel guide plate.

In at least some embodiments, the tubular cutter is a quadrilateral tube body, an edge of a lower opening of the tubular cutter is machined with a cutting edge, an outer surface of the tubular cutter is fixedly connected with a pull plate, and an upper surface of the pull plate is fixedly connected with a tension spring, an upper end of the tension spring is fixedly connected to the lower surface of the parallel guide plate, and the tubular cutter is movably sleeved on the vertical push rod.

In at least some embodiments, a cylinder body of each of the three cartilage positioning thrust cylinders is fixedly connected to an inclined surface of a corresponding one of the three inclined gaskets, the three cartilage pressing plates are parallel to an upper surface of the operating table board, three pressing plate inclined struts are arranged below the three cartilage pressing plates, and slidingly connected to the three inclined guide openings; lower ends of the three pressing plate inclined struts are bent outwards and machined with three strut push plates, and the three strut push plates are fixedly connected to ends of push rods of the three cartilage positioning thrust cylinders.

In at least some embodiments, each of the two rinsing solution sprayers is of an arc structure, an inner surface of each of the two rinsing solution sprayers is provided with sprayer spouts which face inwards and downwards; a flow dividing pipe is fixedly connected to each of the two rinsing solution sprayers and a miniature water pump, and an input pipe of the miniature water pump is arranged inside the rinsing solution reservoir.

The present disclosure provides a full-automatic human primary chondrocyte extraction device, which has the following beneficial effects:

According to the present disclosure, an automatic positioning mechanism for cartilage tissue is arranged on a cell cutting working table for extracting human primary chondrocytes, and cartilage tissue slices can be fixed to the center of the detachable operating table in three directions by the automatic positioning mechanism, which can effectively improve the stability of the cartilage tissue on the detachable operating table, and avoid a situation that the cutting efficiency of the cartilage tissue is reduced as the cutting accuracy is affected due to slippage or deviation in the process of cartilage cutting. A positioning feed direction of the positioning structure is inclined and when the positioning structure is unfolded, the pressing plates extends outwards and upwards to increase the placing space of the cartilage tissue, thus the cartilage tissue can be conveniently placed at the center of the detachable operating table.

In addition, the tubular cutter can move vertically up and down below the parallel guide plate. The cutting edge at a lower end of the tubular cutter is pressed against the cartilage to cut the cartilage on the detachable operating table into small pieces by the vertical downward movement of the tubular cutter, and the position of the tubular cutter in front, rear, left and right directions is controlled by the sliding connection between the parallel guide plate and the parallel guide frame, thus cutting the cartilage tissue continuously. The tubular cutter is pushed upwards after cutting the cartilage tissue, so that the tissue blocks inside the lower end of the tubular cutter are squeezed out by the vertical push rod and dropped on the detachable operating table. Therefore, the working difficulty of cutting the tissue blocks is reduced, and the experimental efficiency is improved.

In addition, the detachable operating table is installed in the middle of the operating table board, which can be taken out from the middle opening for cleaning. After the cutting of the tissue blocks on the detachable operating table is completed, rinsing solution inside the rinsing solution reservoir is conveyed by the miniature water pump and then sprayed through the rinsing solution sprayer to rush the tissue blocks into a gap between the detachable operating table and the middle opening. The tissue blocks can enter the centralized conveying hopper together with the rinsing solution, and are discharged into an experimental vessel through an outlet of the centralized conveying hopper, which is beneficial to the concentration and transfer of the tissue blocks and can improve the convenience of the experiment.

### BRIEF DESCRIPTION OF THE DRAWINGS

To illustrate the technical solution of the embodiments of the present disclosure more clearly, the accompanying drawings of the embodiments are briefly introduced below.

The accompanying drawings described below relate only to some embodiments of the present disclosure, and are not intended to limit the present disclosure.

FIG. 1 is a diagram of an overall structure of a full-automatic human primary chondrocyte extraction device according to the present disclosure;

FIG. 2 is a schematic structural diagram of a bottom of the full-automatic human primary chondrocyte extraction device according to the present disclosure;

FIG. 3 is a schematic structural diagram of an operating table board according to the present disclosure;

FIG. 4 is a schematic structural diagram of a cartilage pressing plate in a lifting state according to the present disclosure;

FIG. 5 is a schematic structural diagram of a rinsing solution sprayer according to the present disclosure;

FIG. 6 is a schematic structural diagram of a parallel guide frame in an exploded state according to the present disclosure;

FIG. 7 is a schematic diagram of an internal structure of a tubular cutter according to the present disclosure;

FIG. 8 is a schematic structural diagram of the cartilage pressing plate according to the present disclosure;

FIG. 9 is a partial enlarged view of section A in FIG. 4 according to the present disclosure; and

FIG. 10 is a partial enlarged view of section B in FIG. 6 according to the present disclosure.

### REFERENCE NUMERALS

1 chondrocyte extraction table; 101 auxiliary lighting component; 102 lighting control switch; 2 operating table board; 201 middle opening; 202 inclined gasket; 203 positioning pad; 204 inclined guide opening; 205 centralized conveying hopper; 3 detachable operating table; 301 support leg; 4 support plate; 5 parallel guide frame; 501 dismounting opening; 502 limit sliding opening; 6 parallel guide plate; 601 vertical push rod; 602 handle; 7 tubular cutter; 701 pull plate; 702 tension spring; 703 cutting edge; 8 cartilage positioning thrust cylinder; 9 cartilage pressing plate; 901 pressing plate inclined strut; 902 strut push plate; 10 rinsing solution sprayer; 1001 sprayer spout; 1002 flow dividing pipe; 1003 miniature water pump; and 11 rinsing solution reservoir.

### DETAILED DESCRIPTION OF THE EMBODIMENTS

To make the objectives, technical solutions and advantages of the present disclosure more clearly, the following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts shall fall within the scope of protection of the present disclosure.

### Embodiment I

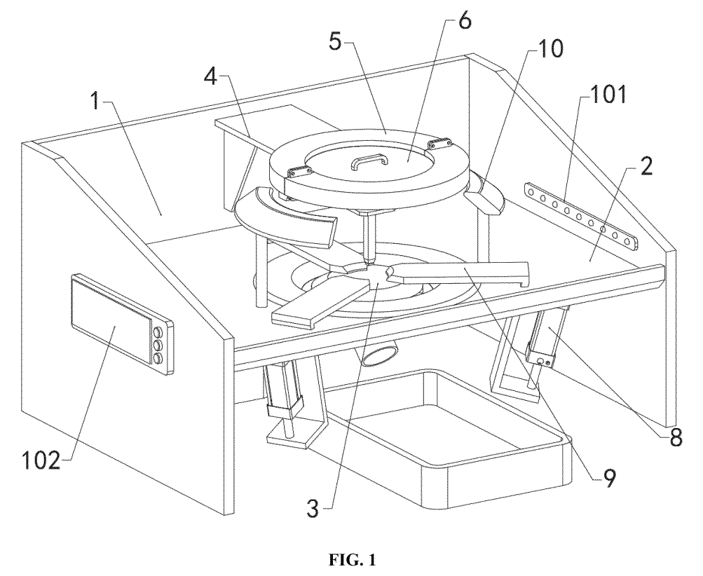

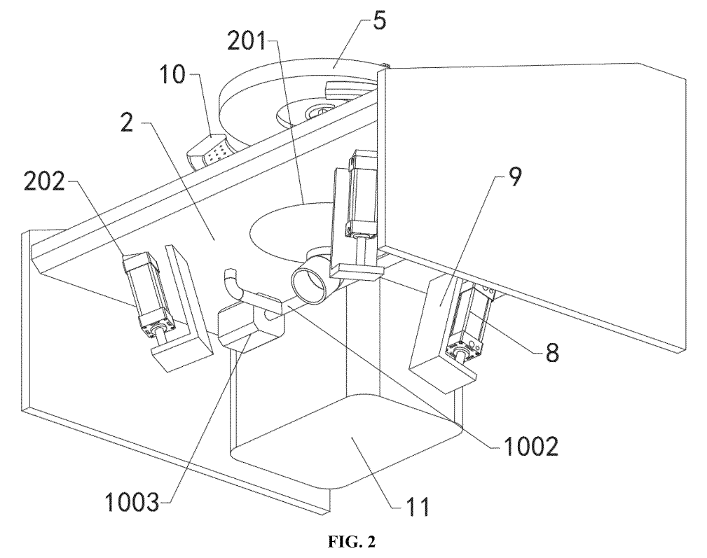

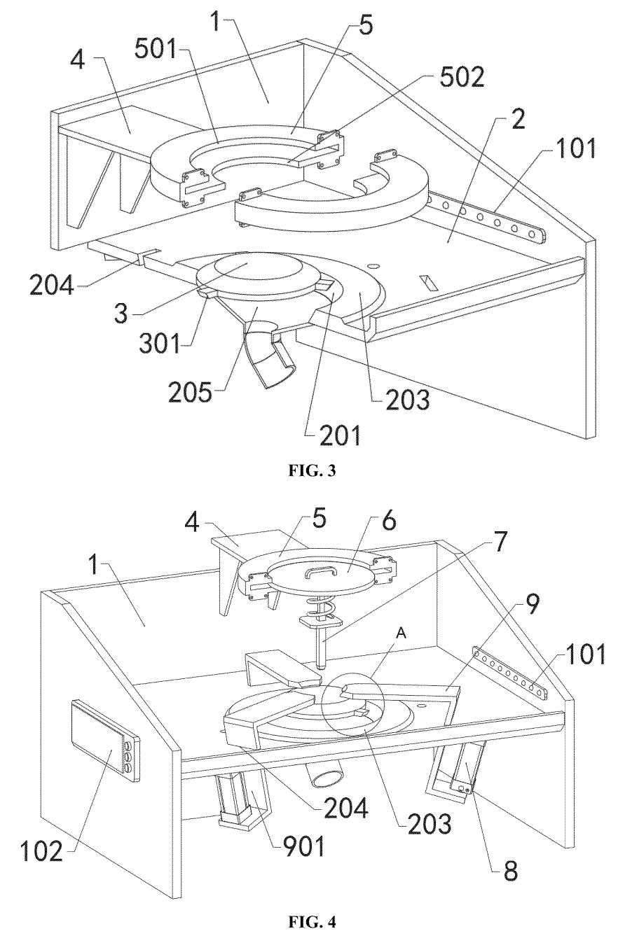

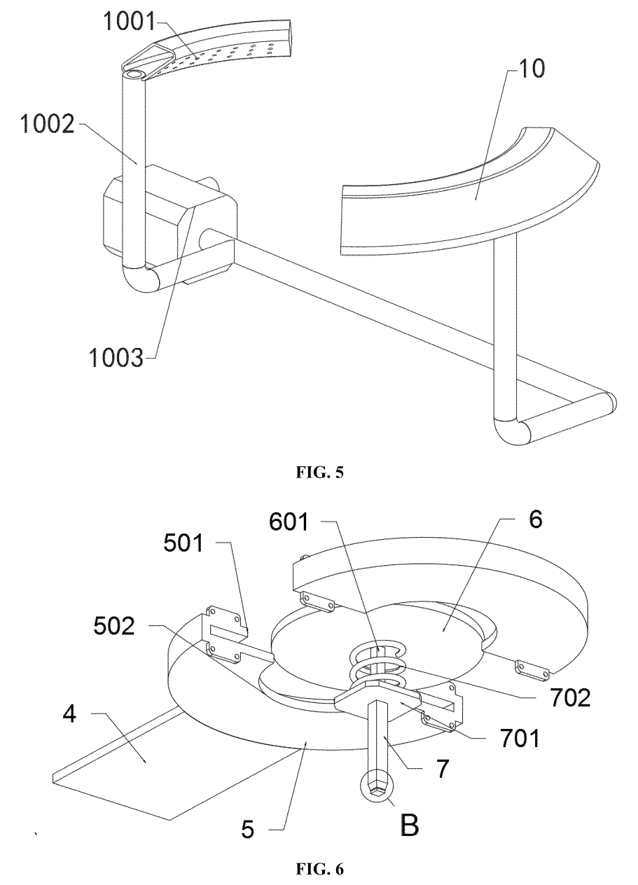

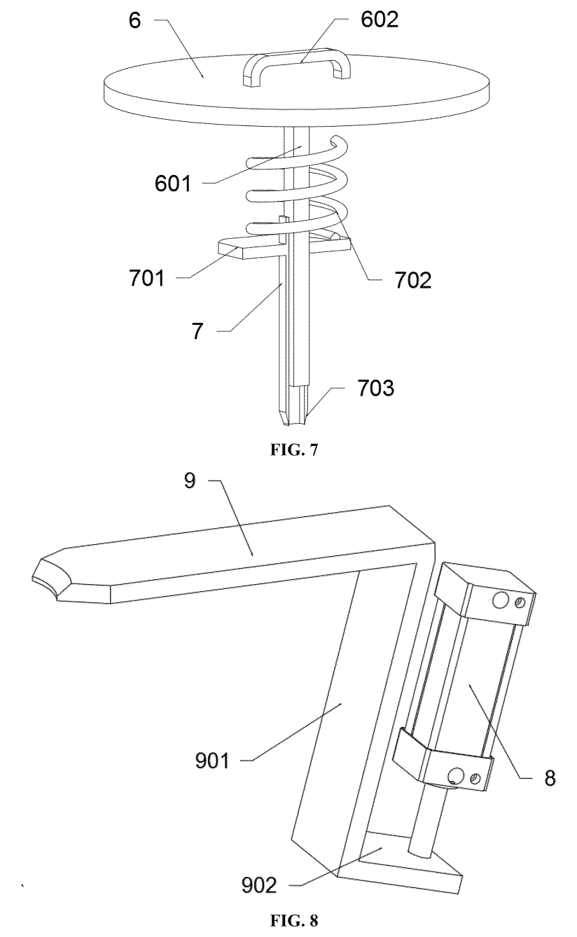

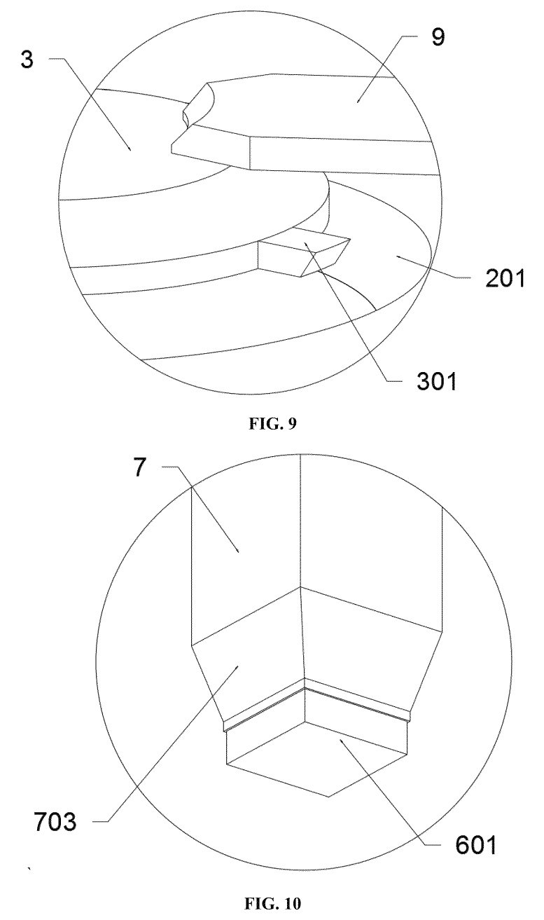

With reference to FIG. 1 to FIG. 10, the present disclosure provides a full-automatic human primary chondrocyte extraction device, including a chondrocyte extraction table 1. Two auxiliary lighting components 101 are installed on an inner wall of the chondrocyte extraction table 1 via screws. A lighting control switch 102 is fixedly connected to a left surface of the chondrocyte extraction table 1, and the two auxiliary lighting components 101 are connected to the lighting control switch 102 via electric wires. The auxiliary lighting components 101 are controlled by the lighting control switch 102 to play the role of auxiliary lighting. An operating table board 2 is fixedly connected to the chondrocyte extraction table 1.A detachable operating table 3 is arranged in the middle of the operating table board 2 and a support plate 4 is fixedly connected to an inner upper portion of the chondrocyte extraction table 1. A parallel guide frame 5 is installed on a front end of the support plate 4. The parallel guide frame 5 is composed of two semicircular frames spliced together via bolts and a parallel guide plate 6 is movably connected into the parallel guide frame 5. A tubular cutter 7 is arranged under the parallel guide plate 6 and three cartilage positioning thrust cylinders 8 are installed on a lower surface of the operating table board 2 via screws. Three cartilage pressing plates 9 are movably connected to the operating table board 2, and two rinsing solution sprayers 10 are installed above the chondrocyte extraction table 1 and connected to a rinsing solution reservoir 11.

In the embodiment of the present disclosure, a front edge of the operating table board 2 is bent upwards and the middle of the operating table board 2 is provided with a circular middle opening 201.An edge of the middle opening 201 is inclined. Three inclined gaskets 202 are fixedly connected to the lower surface of the operating table board 2 and uniformly distributed in a radial pattern around an axis of the middle opening 201. An inclined surface of each inclined gasket 202 faces inwards and downwards, and an outer edge of the middle opening 201 is provided with a positioning pad 203 of a convex ring structure. The detachable operating table 3 is of a truncated cone structure. An outer edge of the detachable operating table 3 is fixedly connected with three support legs 301 The detachable operating table 3 is installed inside the middle opening 201, and outer ends of the support legs 301 are fitted to an inner edge of the middle opening 201. An upper surface of the detachable operating table 3 is flush with an upper surface of the positioning pad 203 and supported to an inner inclined surface of the middle opening 201 through the support legs 301. The detachable operating table 3 is configured to place the primary chondrocytes and support the cutting of the cartilage tissue.

In the embodiment of the present disclosure, the parallel guide frame 5 is internally provided with a circular cavity, and a middle of the upper portion of the parallel guide frame 5 is provided with a dismounting opening 501. An inner diameter of the dismounting opening 501 is equal to a diameter of the parallel guide plate 6, and a middle of the lower portion of the parallel guide frame 5 is provided with a limit sliding opening 502. The two semicircular frames are assembled to form the parallel guide frame 5, which is easy to clean after being disassembled. The limit sliding opening 502 enables the parallel guide plate 6 to adjust its position in a horizontal direction, and the dismounting opening 501 facilitates the vertical upward removal and disassembly of the parallel guide plate 6, which is convenient for cleaning and disinfecting the parallel guide plate 6 and the tubular cutter 7.

In the embodiment of the present disclosure, a vertical push rod 601 is vertically arranged on the middle of a lower surface of the parallel guide plate 6 where a cross section of the vertical push rod 601 is square, and an upper surface of the parallel guide plate 6 is fixedly connected with a handle 602. The tubular cutter 7 is a quadrilateral tube body. An edge of a lower opening of the tubular cutter 7 is machined with a cutting edge 703. A pull plate 701 is fixedly connected to an outer surface of the tubular cutter 7, and an upper surface of the pull plate 701 is fixedly connected with a tension spring 702. An upper end of the tension spring 702 is fixedly connected to the lower surface of the parallel guide plate 6, and the tubular cutter 7 is movably sleeved on the vertical push rod 601. The tubular cutter 7 can move vertically up and down below the parallel guide plate 6. The cutting edge 703at a lower end of the tubular cutter 7 is pressed against the cartilage to cut the cartilage on the detachable operating table 3 into small pieces by the vertical downward movement of the tubular cutter 7. The position of the tubular cutter 7 in front, rear, left and right directions is controlled by the sliding connection between the parallel guide plate 6 and the parallel guide frame 5, thus cutting the cartilage tissue continuously. The tubular cutter 7 is pushed upwards after cutting the cartilage tissue, so that the tissue blocks inside the lower end of the tubular cutter 7 are squeezed out by the vertical push rod 601 and dropped on the detachable operating table 3.

In the embodiment of the present disclosure, three inclined guide openings 204 are formed in the operating table board 2 in a penetrating manner. The three inclined guide openings 204 are arranged in an inclined manner and uniformly distributed in a radial pattern around the axis of the middle opening 201. A centralized conveying hopper 205 is fixedly connected to the lower surface of the operating table board 2 and includes an upper edge that surrounds a lower opening of the middle opening 201.A conveying pipe is installed on a lower outlet of the centralized conveying hopper 205. A cylinder body of the cartilage positioning thrust cylinder 8 is fixedly connected to the inclined surface of the inclined gasket 202. The cartilage pressing plate 9 is parallel to an upper surface of the operating table board 2 and a pressing plate inclined strut 901 is arranged below the cartilage pressing plate 9, and slidingly connected to the inclined guide opening 204. A lower end of the pressing plate inclined strut 901 is bent outwards and machined with a strut push plate 902 that is fixedly connected to an end of a push rod of the cartilage positioning thrust cylinder 8. The cartilage positioning thrust cylinder 8 controls the inclined extension and retraction of the cartilage pressing plate 9, thereby positioning the cartilage tissue and pressing the cartilage tissue tightly.

### Embodiment II

On the basis of Embodiment I, the rinsing solution sprayer 10 is of an arc structure, and an inner surface of the rinsing solution sprayer 10 is provided with sprayer spouts 1001 which face inwards and downwards. A flow dividing pipe 1002 is fixedly connected to the rinsing solution sprayer 10 and a miniature water pump 1003. An input pipe of the miniature water pump 1003 is arranged inside the rinsing solution reservoir 11. The rinsing solution inside the rinsing solution reservoir 11 is conveyed to the rinsing solution sprayer 10 by the miniature water pump 1003 and sprayed inclinedly downward through the sprayer spouts 1001 to rush the cut cartilage tissue into the centralized conveying hopper 205, and then the cut cartilage tissue is stored in an experimental vessel at the bottom of the centralized conveying hopper 205.

The working principle of the embodiment is as follows: firstly, the extracted human cartilage tissue is placed on the detachable operating table 3, the auxiliary lighting components 101 are turned on to provide auxiliary lighting for the detachable operating table, and the three cartilage positioning thrust cylinders 8 are controlled to push the strut push plates 902 downwards to move the cartilage pressing plates 9 downwards to clamp the cartilage tissue on the detachable operating table 3. The miniature water pump 1003 is controlled to be turned on to convey the rinsing solution inside the rinsing solution reservoir 11 to the rinsing solution sprayer 10 to wash the cartilage tissue, and then the cartilage tissue is cut. During cutting of the cartilage tissue, the tubular cutter 7 is held with a hand and pushed vertically downwards to make the cutting edge 703 in contact with the upper surface of the cartilage tissue, and the cutting edge 703 cuts into the cartilage tissue and divides the cartilage tissue into small-volume tissue blocks by applying downward force to the tubular cutter 7. Afterwards, the tubular cutter 7 is lifted to make the vertical push rod 601 squeeze the cartilage tissue inside the bottom of the tubular cutter 7 out, which then falls onto the detachable operating table 3. The parallel guide plate 6 is moved horizontally to change the position of the tubular cutter 7 to continue to cut the cartilage tissue. After the cutting is completed, the miniature water pump 1003 is controlled to be turned on to convey the rinsing solution inside the rinsing solution reservoir 11 to the rinsing solution sprayer 10, and the rinsing solution is sprayed through the sprayer spouts 1001 to rush the small-volume tissue blocks on the detachable operating table 3 into the centralized conveying hopper 205. An experimental vessel is placed at the bottom of the centralized conveying hopper 205, and the small-volume tissue blocks are conveyed into the experimental vessel by the rinsing solution for concentration to complete the tissue block cutting in the chondrocyte extraction process, and the tissue blocks are further processed to extract the internal primary chondrocytes according to the experimental steps.

There are several points to note herein:

The accompanying drawings of the embodiments of the present disclosure only relate to the structures related to the embodiments of the present disclosure, and other structures can refer to the general design.

It should be noted that the embodiments of the present disclosure and features in the embodiments may be combined with each other without causing conflict to obtain a new embodiment.

The above is only the specific implementation of the present disclosure, but the scope of protection of the present disclosure is not limited thereto. Any change or substitution that can be easily thought of by any person skilled in the art within the technical scope disclosed in the present disclosure should be covered by the scope of protection of the present disclosure. Therefore, the scope of protection of the present disclosure shall be subject to the appended claims.

What is claimed is:

1. A full-automatic human primary chondrocyte extraction device, comprising:
a chondrocyte extraction table;
an operating table board fixedly connected to the chondrocyte extraction table;
a detachable operating table arranged in a middle of the operating table board;
a support plate fixedly connected to an inner upper portion of the chondrocyte extraction table;
a parallel guide frame installed on a front end of the support plate,
wherein the parallel guide frame is composed of two semicircular frames spliced together via bolts, a parallel guide plate is movably connected into the parallel guide frame, a tubular cutter is arranged under the parallel guide plate, three cartilage positioning thrust cylinders are installed on a lower surface of the operating table board via screws, three cartilage pressing plates are movably connected to the operating table board, and
two rinsing solution sprayers are installed above the chondrocyte extraction table and connected to a rinsing solution reservoir.

2. The full-automatic human primary chondrocyte extraction device according to claim 1, further comprising:
two auxiliary lighting components installed on an inner wall of the chondrocyte extraction table via screws, and
a lighting control switch fixedly connected to a left surface of the chondrocyte extraction table and connected to the two auxiliary lighting components via electrical wires.

3. The full-automatic human primary chondrocyte extraction device according to claim 1, wherein:
the operating table board includes a front edge that is bent upwards;
a circular middle opening is provided at a middle of the operating table board, an edge of the middle opening is inclined;
three inclined gaskets are fixedly connected to the lower surface of the operating table board and uniformly distributed in a radial pattern around an axis of the middle opening, an inclined surface of each of the three inclined gaskets faces inwards and downwards, and an outer edge of the middle opening is provided with a positioning pad of a convex ring structure.

4. The full-automatic human primary chondrocyte extraction device according to claim 3, further comprising:
three inclined guide openings formed in the operating table board in a penetrating manner and uniformly distributed in a radial pattern around the axis of the middle opening,
a centralized conveying hopper fixedly connected to the lower surface of the operating table board and including an upper edge surrounding a lower opening of the middle opening, and
a conveying pipe installed on a lower outlet of the centralized conveying hopper.

5. The full-automatic human primary chondrocyte extraction device according to claim 3, wherein the detachable operating table is of a truncated cone structure, an outer edge of the detachable operating table is fixedly connected with three support legs, the detachable operating table is installed inside the middle opening, and outer ends of the three support legs are fitted to an inner edge of the middle opening.

6. The full-automatic human primary chondrocyte extraction device according to claim 1, wherein the parallel guide frame is internally provided with a circular cavity, a middle of an upper portion of the parallel guide frame is provided with a dismounting opening, an inner diameter of the dismounting opening is equal to a diameter of the parallel guide plate, and a middle of a lower portion of the parallel guide frame is provided with a limit sliding opening.

7. The full-automatic human primary chondrocyte extraction device according to claim 1, further comprising:
a vertical push rod vertically arranged on a middle of a lower surface of the parallel guide plate, a cross section of the vertical push rod is square, and
a handle fixedly connected to an upper surface of the parallel guide plate.

8. The full-automatic human primary chondrocyte extraction device according to claim 7, wherein
the tubular cutter is a quadrilateral tube body, an edge of a lower opening of the tubular cutter is machined with a cutting edge,
an outer surface of the tubular cutter is fixedly connected with a pull plate, and
an upper surface of the pull plate is fixedly connected with a tension spring, an upper end of the tension spring is fixedly connected to the lower surface of the parallel guide plate, and the tubular cutter is movably sleeved on the vertical push rod.

9. The full-automatic human primary chondrocyte extraction device according to claim 4, wherein:
a cylinder body of each of the three cartilage positioning thrust cylinders is fixedly connected to an inclined surface of a corresponding one of the three inclined gaskets,
the three cartilage pressing plates are parallel to an upper surface of the operating table board, three pressing plate inclined struts are arranged below the three cartilage pressing plates, and slidingly connected to the three inclined guide openings; and
lower ends of the three pressing plate inclined struts are bent outwards and machined with three strut push plates, and the three strut push plates are fixedly connected to ends of push rods of the three cartilage positioning thrust cylinders.

10. The full-automatic human primary chondrocyte extraction device according to claim 1, wherein each of the two rinsing solution sprayers is of an arc structure, an inner surface of each of the two rinsing solution sprayers is provided with sprayer spouts face inwards and downwards; and a flow dividing pipe is fixedly connected to each of the two rinsing solution sprayers and a miniature water pump, an input pipe of the miniature water pump is arranged inside the rinsing solution reservoir.
